(19) United States
(12) Patent Application Publication
(10) Pub. No.: US 2006/0272253 A1
(43) Pub. Date: Dec. 7, 2006

(54) Composite garage doors and processes for making such doors

(76) Inventors: Steven J. Wolf, Holy Cross, IA (US); David Evan Hill, Escondido, CA (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 10/997,244

(22) Filed: Nov. 24, 2004

(51) Int. Cl. E06B 3/70

(52) U.S. Cl. 52/455

(57) ABSTRACT

Disclosed are products, such as door panels and doors, made using a thin-layer lignocellulose composite that includes a region of increased thickness to provide at least one raised surface, such that the surface comprises the appearance of wooden planking and/or wooden trim. The raised surface may be provided by a lignocellulose composite plant-on structure, and/or by cutting grooves in the surface of the thin-layer lignocellulose composite. The plant-on structures and/or grooves may be positioned so that a multi-paneled door has the appearance of single-panel door. Processes for forming such door panels and doors are also disclosed.

### FIELD OF INVENTION

The present invention relates to the manufacture of composite doors, such as composite garage doors.

### BACKGROUND OF THE INVENTION

Doors manufactured from wood have a pleasing appearance and a substantial and solid feel. While the appearance of natural wood is aesthetically pleasing, wood can be susceptible to damage caused by long-term exposure to humid or dry air, weather, fungal infestation, and insect pests. Thus, frequent and often costly maintenance may be required to prevent the deterioration of finished wood that is exposed to the environment. Also, many species of wood having a desirable appearance are expensive, and require significant labor and time for production of finished articles.

Metal doors may be more cost-efficient than wood to manufacture and maintain, but may not be as aesthetically pleasing to the consumer. For example, metal garage doors may only be available in limited color lines and often do not simulate a natural wood grain in a very realistic manner. Also, metal garage doors may be limited in design, in that it may be difficult to add three dimensional shaping, such as trim or paneling, to the outer surface of a metal door. For example, some manufacturers apply extrusive plastic panels to the face of a metal garage door to add a design to the face of the door. The plastic and metal components, however, may exhibit different physical properties in response to changes in temperature and humidity and thus, the door may exhibit warping or other types of deformation upon exposure to weather.

Multi-paneled, roll-up garage doors have become standard in the industry. Many consumers, however, desire the convenience of a multi-panel roll-up garage door, but prefer the look of a traditional one-piece (lift-up, swing, or sliding) garage door that is typical of Tudor or other types of traditional architecture. Such single panel garage doors include design features, such as trim and vertical paneling, that utilize the entire face of the garage door to provide an appearance that is distinguishable from the multi-paneled look typical of a roll-up door.

Thus, there is a need for a product and a process that addresses some or all of the above-mentioned disadvantages. Further, what is needed is a garage door that combines the convenience of a multi-panel roll-up garage door with the look of a traditional one-piece garage door. Also, what is needed is a garage door that combines the aesthetics of a wooden garage door with the durability and low maintenance typically found with metal garage doors.

### SUMMARY OF THE INVENTION

The present invention comprises composite doors and processes for making such doors. The present invention may be embodied in a variety of ways.

One embodiment of the present invention comprises a product, such as a door panel, comprising a thin-layer lignocellulose composite that comprises a region of increased thickness to provide at least one raised surface, such that the raised surface comprises the appearance of at least one of wooden planking or wooden trim.

Another embodiment of the present invention comprises a door comprising a plurality of panels, wherein at least one panel comprises a thin-layer lignocellulose composite comprising a region of increased thickness to provide at least one raised surface, such that the raised surface comprises the appearance of at least one of wooden planking or wooden trim. The raised surface may be coordinated with other panels of the door so as to create a multi-paneled door having the appearance of a single panel.

Embodiments of the present invention may also comprise processes for making a product comprising a thin-layer lignocellulose composite comprising a region of increased thickness to provide at least one raised surface, such that the surface comprises the appearance of at least one of wooden planking or wooden trim. In one embodiment, the process may comprise the steps of preparing at least one thin-layer lignocellulose composite comprising a substantially flat surface and at least one of the following: making at least one cut into the surface of the composite to provide a raised surface, or attaching at least one thin-layer lignocellulose plant-on structure to the surface of the thin-layer lignocellulose composite to form a raised surface.

Other embodiments of the processes of the present invention may be used to make panels for composite doors, such as composite garage doors. To make a door panel, the process may comprise the steps of assembling a frame for the panel and positioning the frame on a first thin-layer lignocellulose composite. In some cases, a core material may be added to at least part of the area within the frame. Next, a second thin-layer composite may be positioned on top of the frame, and treated to provide a raised surface.

There may be certain advantages associated with various embodiments of the present invention. Composite garage doors of the present invention may effectively simulate the appearance and overall feel of a solid, single-piece wood garage door. Also, composite garage doors of the present invention may have design capabilities that heretofore were not possible with multi-paneled roll-up garage doors. In one embodiment, the plant-on structure may provide the outer surface of the door panel with a pattern that may be coordinated with other panels of the garage door so as to create a roll-up multi-paneled garage door with a single, unified design on its outer face, such that multiple horizontal panels appear as a single panel door.

The texture and overall appearance of exemplary composite doors of the present invention may effectively simulate wood. For example, certain embodiments of the present invention may have a grain appearance that is very much like real wood. Also, the composite doors of the present invention may have the solid sound and feel of wood, since the composite door may include a core of polymer foam having a density similar to the density of wood.

Embodiments of composite doors of the present invention may also be more durable than solid wood doors, but may require substantially less maintenance than solid wood doors. Thus, certain composite doors of the present invention may be less susceptible than solid wood doors to damage caused by long-term exposure to humid or dry air, weather, fungal infestation, and insect pests. Also, the composite doors may not dent or rust as may occur with metal garage doors. Additionally, because they can be painted with commonly available acrylic latex exterior paints, the composite doors of the present invention may be custom-finished to match a variety of building styles.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE FIGURES

FIG. 1 shows a perspective view of a composite single car garage door in accordance with an illustrative embodiment of the present invention with enlargements of indicated portions of the door shown in FIG. 1A and FIG. 1B.

FIG. 2 shows a front view of a composite single car garage door in accordance with an illustrative embodiment of the present invention.

FIG. 3 shows a perspective view of a composite two car garage door in accordance with an illustrative embodiment of the present invention.

FIG. 4 shows a composite two car garage door in accordance with an illustrative embodiment of the present invention with an enlargement of the indicated region shown in FIG. 4A.

FIG. 5 shows a composite two car garage door in accordance with an illustrative embodiment of the present invention with an enlargement of the indicated region shown in FIG. 5A.

FIG. 6 shows a perspective view of various components used to make a composite garage door in accordance with an illustrative embodiment of the present invention.

FIG. 7 shows a process used to manufacture composite garage door panels in accordance with an example embodiment of the present invention, where FIG. 7A shows a process used to make a flush door panel, and FIG. 7B shows processes used to add raised surfaces to flush door panels.

### DETAILED DESCRIPTION

Embodiments of the present invention comprise products such as panels for composite doors and doors made using such panels. Thus, one embodiment of the present invention may comprise a product comprising a thin-layer lignocellulose composite that comprises a region of increased thickness to provide at least one raised surface, such that the raised surface comprises the appearance of wooden planking and/or wooden trim. The raised surface may comprise a lignocellulose composite plant-on structure in communication with the thin-layer lignocellulose composite. Alternatively and/or additionally, the raised surface may be formed by making at least one cut in the thin layer composite such that the portion of the composite next to the cut-out region comprises a raised surface. In alternate embodiments, the cut-out portion may comprise grooves or other types of hollowing of the thin-layer lignocellulose composite.

The product may comprise any building structure for which it may be desired to emulate a surface having the appearance of at least one of wooden planking or wooden trim. For example, the thin-layer lignocellulose composite may comprise a surface of a door panel. In one embodiment, the panel may comprise a panel for a garage door.

Embodiments of the present invention may also comprise doors comprising a plurality of panels, wherein at least one panel comprises a thin-layer lignocellulose composite comprising a region of increased thickness to provide at least one raised surface, such that the raised surface comprises the appearance of wooden planking and/or wooden trim. The raised surface may comprise a lignocellulose composite plant-on in communication with the thin-layer lignocellulose composite, and/or the raised surface may be formed by cutting grooves or other types of hollowing of the thin-layer lignocellulose composite. In one embodiment, the door may comprise a garage door.

As used herein, “lignocellulose” comprises a material containing both cellulose and lignin. Suitable lignocellulosic materials may include wood particles, wood fibers, straw, hemp, sisal, cotton stalk, wheat, bamboo, jute, salt water reeds, palm fronds, flax, groundnut shells, hard woods, or soft woods, as well as fiberboards such as high density fiberboard (HDF), medium density fiberboard (MDF), oriented strand board, and particle board. In an embodiment, the lignocellulosic fiber is refined. As used herein, refined fiber may comprise fibers and fiber bundles that have been reduced in size from other forms of a lignocellulose substrate such as chips and shavings. In an embodiment, the lignocellulosic composites of the present invention comprise wood fiber. Refined wood fiber may be produced by softening the larger wood particles with steam and pressure and then mechanically grinding the wood in a refiner to produce the desired fiber size.

As used herein, a “lignocellulose composite” comprises a product produced by bonding lignocellulose fibers by heat and pressure. Such composites may use a resin to promote bonding of the lignocellulose fibers. For example, lignocellulosic composite products may include high density fiberboard (HDF), medium density fiberboard (MDF), hardboard, particleboard, oriented strand board (OSB), and other panel products.

Also as used herein, a “thin-layer composite” comprises a flat, planar structure that is significantly longer and wide than it is thick. Examples of thin-layer lignocellulosic composites include wood-based door skins that are used to cover the frame of a door to provide the outer surface of the door. Such door skins may be only a few millimeters (mm) thick, but may have a surface area of several square feet or more. For example, a standard door skin for a single garage door panel may be about 24 inches wide by about 112 inches long and about ⅛ inch thick.

As used herein, a “plant-on” comprises a structure that may be adhered to, or “planted-on” the inner or outer surface of a planar object to provide a raised surface. In one embodiment, the plant-on structure may comprise a decorative trim. The plant-on structure may be made of a material that is compatible with the surface to which it is being adhered. For example, for a lignocellulose door or panel, a plant-on may comprise a lignocellulose composite. The plant-on structure may have a variety of shapes or forms. In one embodiment, the plant-on structure may be about ⅜ inch thick and rectangular in shape. Or, a plant-on may comprise a lignocellulosic composite structure that is ½ inch thick and oval or round in shape.

As used herein, a cut out portion comprises a type of cut or gouge made in a surface. For example, a flat or flush door skin may have grooves that are about ⅛ inch deep and ⅜ inch wide routed in the door skin. The grooves may be substantially linear, or they may be shaped to form a decorative molding.

Also, as used in describing the various surfaces of the thin-layer composites (e.g., door skins), the term “outer surface” refers to the surface of the thin-layer composite that is exposed on either face of a composite door panel, and the term “inner surface” refers to the surface that is adjacent to the frame and inner core of the panel. In contrast, the term “outside surface” or “outside facing surface” refers to the surface of the panel that is (or is designed to be) facing the outside of a building, and the term “inside surface” or “inside facing surface” refers to the surface of the garage panel that is (or that is designed to be) facing the inside of the building. Also, a substantially flat surface comprises a surface that may have some grain or some other pattern into the surface, but that does not comprise regions of high relief. In contrast, a raised surface comprises a design that stands out, or projects from the surface.

The plant-on attached to the thin layer composite, and/or the groove or other hollowing cut into the thin-layer composite, may be used to provide the outer surface of a door panel with a pattern. The pattern may provide a single-paneled door with a desired design feature. Alternatively, the pattern may be coordinated with other panels of a multi-paneled door so as to create a door having the appearance of a single panel door. The raised surface provided by the plant-on and/or the grooves may be used to form a garage door having multiple horizontal panels that has the appearance of a single panel spanning the vertical axis of the garage door.

For example, embodiments of the present invention may comprise products having a plurality of plant-ons attached to the surface of the thin layer composite and/or grooves or other types of cut-out portions cut into the surface of the thin-layer composite. The plurality of plant-ons and or grooves may comprise a repeating pattern. Alternatively and/or additionally, plant-ons or grooves positioned on the surface of one panel may be coordinated with the pattern of plant-ons or grooves on another panels used to form a pattern that extends over multiple panels.

The plant-ons may be positioned on a door comprising a substantially flat, or flush thin layer composite door skin. Alternatively, the plant-ons may be positioned on a door skin that has been cut out or routed to have grooves or some other design.

The plant-on structure may be in direct communication with the outer surface of the thin-layer composite structure. Alternatively, and/or additionally, a plant-on structure may be in direct communication with the inner surface of the thin-layer composite structure. In one embodiment, the outer or inner surface in communication with the plant-on corresponds to the outside surface of the door. Or, the outer or inner surface in communication with the plant-on may correspond to the inside surface of the door. Thus, a plant-on may be adhered to the outside facing surface of the garage door, or the inside facing surface of the garage door, or to both inside and outside facing surfaces of the garage door.

The thin-layer composite and the plant-on may both be made of the same lignocellulose material. In one embodiment, a lignocellulosic material comprises a lignocellulosic fiber and a resin. For example, the lignocellulose material used for the plant-ons and the thin-layer composite to which the plant-on is attached may comprise medium density fiberboard made with a melamine-formaldehyde resin.

In some cases, the plant-ons are only used for the outside surface of the door panel or door. The thin-layer used on the composite that does not comprise a plant-on structure may comprise a material that is the same as, or different than, the material used for the thin-layer composite that comprises the plant-on. Also, because the inside of the door is not as exposed to the elements as the outside of the door, a thin-layer composite that is less weather resistant may be used. In an embodiment, the thin-layer used on the face of the door panel that does not comprise a plant-on (e.g., the inside door skin) is also a lignocellulose composite. For example, a high density fiberboard (HDF) or a medium density fiberboard (MDF) thin-layer composite may be used for the inside door skin.

The plant-ons may be adhered onto the thin-layer composite that will form the outer surface of the door using a polyvinyl acetate glue or a hot-melt glue. Other adhesives, such as double-sided sticky tape may also be used. Additionally, and/or alternatively, the plant-ons may be positioned using small fasteners such as nails. Also, a sealant may be used to prevent delamination of the applied plant-ons from the panel. In one example embodiment, a silicone sealant, such as an acrylic silicone caulk, may be used. Also, both the thin-layer lignocellulose composite and the plant-on may comprise a resin. Thus, in one embodiment, the plant-on may be bonded to the thin-layer composite by pressing the plant-on onto the thin-layer composite such that the two composites form a singular composite and the plant-on becomes part of the thin-layer composite door skin.

By having the thin-layer composite and the plant-ons formulated from the same material, there may be reduced stress at the point of attachment of the plant-ons since both materials will exhibit the same physical characteristics. For example, when made from the same material, both the thin-layer panel and the plant-on may shrink or swell in response to changes in moisture and/or temperature in a similar fashion, resulting in reduced stress at the point of plant-on attachment as the door is exposed to environmental weathering.

The plant-ons may be a variety of shapes and sizes such that they stand out from the surface of the thin-layer lignocellulose composite door skin to provide a raised surface or relief. In various alternative embodiments, the plant-ons may range from about 1/16 to about 2 inches in thickness, or from about ⅛ inch to 1 inch in thickness, or from about ¼ inch to ¾ inch in thickness. In one example embodiment, the plant-on may be about ⅜ inch thick.

As described above, the thin layer composite may comprise cut-out portions as a means to provide a raised surface. In one embodiment, the cut-out portions may be substantially linear, to appear as spaces between plank boards. For example, grooves may be spaced apart in a regular fashion across the surface of the thin-layer composite. Or the cut-out portions may be non-linear in shape, such that the raised portions appear as decorative moldings. In one embodiment, the cut-out portions are grooves that may range from about 1/16 to ½ deep into the surface of the thin layer composite and from about 1/16 to 1 inch wide across the groove. In an embodiment, grooves about ⅛ inch deep into the surface of the thin-layer lignocellulose composite and about ⅜ inch wide across may be used. Also, the spacing between the cut-out portions may be varied. Where the raised surface is designed to appear as planking, the grooves may be spaced apart in a regular fashion. In one example embodiment, grooves may be spaced about four to eight inches apart.

The thin-layer composite comprising a raised surface may comprise a variety of thickness ranges based in part on the method used to make the raised surface. For example, where the thin-layer composite is cut out at least in part, a thicker composite may be used. In alternate embodiments, where a portion of the thin-layer composite is cut out, the thin layer composite may range from about ⅛ inch to about 1 inch, or from about ¼ inch to about ½ inch in thickness. Alternatively, where plant-ons are used to form the raised surface, the thin layer composite may be somewhat thinner. For example, where plant-ons are used to provide a raised surface, and the thin-layer composite is not cut out, the thin-layer composite may range in thickness from about 1/16 inch to about ½ inch, or from about ⅛ inch to about ¼ inch.

The products (e.g., door panels and doors) the present invention may further comprise a frame to form the door panel. The frame may comprise at least two vertical stiles and two horizontal rails. As is known in the art, the frame of the composite door panel may be designed to provide support for the door. Also, in one embodiment, the frame may be fashioned so that adjacent panels in a door may interlock. For example, the rails of the frame may be banded with pieces of pine or other types of wood to provide a means to have adjacent panels interlock. The band may include a protruding element (i.e., a tongue), or the band may include a groove. In this way, the protruding element on the end of one door panel may be inserted into a groove on the end of another panel to provide an almost seamless, interlocking junction between the two panels.

In one embodiment, the frame is made using laminated veneer lumber (LVL). LVL is a structural lumber manufactured from veneers laminated into a panel. In most cases, the LVL is made with the grain of all the veneers running parallel to each other. Or, for some applications, the veneers may be placed at right angles to each other. LVL may be manufactured from thin veneers that are rotary peeled or sliced, dried, and laminated together under heat and pressure with a structural adhesive. LVL is generally used for applications requiring high strength. Also, because lumber is a type of lignocellulose, adhesion of the thin-layer lignocellulose composite door skin to the frame may be promoted.

The doors and door panels of the present invention may also comprise a core material emplaced within, and bounded by, the frame and the two thin-layer composites that form the inside and outside surfaces of the panel. The core may be made of a variety of materials. The core may, for example, comprise a synthetic polymer foam. Thus, the core may comprise an expanded polystyrene (EPS) foam or a polyurethane foam. Alternatively LVL or cardboard may be used to at least partly fill the core. In other embodiments, the doors and/or door panels are substantially hollow such that the core comprises a substantial proportion of air.

The core material may comprise a density similar to the density of wood. In one embodiment, expanded polystryrene having a density of from about 1.0 to about 1.5 pounds per cubic foot (pcf) is used. In this way, the composite doors and door panels of the present invention may have the same “feel” as a wood door. For example, the composite door panel and/or door may sound like a wood door. Also, the composite door and/or door panel may have a weight that is similar to a solid wood door.

In one embodiment, the door panel may comprise translucent panels, e.g., windows made of glass, or plexiglass, or the like, inserted within the perimeters of the frame. The surface surrounding the glass panels may be flush with the outer surface of the panel, or it may comprise a plant-on or other type of trim to accentuate the window pane.

The present invention also comprises processes to make products such as composite doors and door panels having a raised surface or high relief design. In one embodiment, such doors and door panels may be used for garage doors.

For example, one embodiment of the present invention comprises a process for making a thin-layer lignocellulose composite comprising a region of increased thickness to provide at least one raised surface, such that the surface comprises the appearance of at least one of wooden planking or wooden trim, comprising the steps of: (a) preparing at least one thin-layer lignocellulose composite comprising a substantially flat surface and at least one of the following: (b) making at least one cut into the substantially flat surface of the composite to provide a raised surface, or (c) attaching and at least one thin-layer lignocellulose plant-on structure to the surface of the thin-layer lignocellulose composite to form a raised surface. In alternate embodiments, the cut-out portion may comprise grooves or other types of hollowing of the thin-layer lignocellulose composite.

The process may further comprise the steps of: (i) assembling a frame for a panel; and (ii) positioning the thin-layer composite on the frame to form at least part of the outer surface of the panel. In one embodiment, step (i) is performed prior to step (a) above, and step (ii) is performed prior to steps (b) and/or (c) above, such that the thin-layer composite is assembled on a frame prior to positioning the plant-on and/or making any cuts in the thin-layer surface. The panel may comprise a panel for a door. In one embodiment, the panel comprises a panel for a garage door.

In one embodiment, the raised surface is positioned on a thin-layer composite that comprises the outside surface of a panel. Additionally, a plant-on may be adhered to the surface of the door that will be the inside surface of a panel, or to both the outside and the inside surface of a panel.

The process may, in one embodiment, further comprise placing the frame on a second thin-layer substrate to form an enclosed panel prior to positioning the thin-layer composite that is to be treated to provide a raised surface. In one embodiment, the second thin-layer substrate comprises a side of the door that does not require a plant-on. Where the second thin-layer substrate does not require a plant-on, the thin-layer used on the second face of the garage door panel may comprise a material that is the same as, or different than, the material used for the face of the panel comprising the plant-on. In one embodiment, the thin-layer used on the second face of the garage door panel is a lignocellulose composite. For example, a high density fiberboard thin-layer composite may be used for the door panel that does not comprise a plant-on.

Also, in one embodiment, a core material may be emplaced within, and bounded by, the frame and the two thin-layer composites that form the inside and outside surface of door panel. The core may be made of a variety of materials. The core may, for example, comprise a synthetic polymer foam. Thus, the core may comprise an expanded polystyrene (EPS) foam or a polyurethane foam. Alternatively, other core materials such as cardboard or LVL may be used. Or the core may be substantially hollow, such that it is filed with air.

Embodiments of the present invention also comprise processes for making composite door panels where the panels have at least one raised surface such that the surface comprises the appearance of wooden planking and/or wooden trim. In one embodiment, the process comprises the steps of: (a) assembling a frame for the panel; (b) optionally, adding a core material to at least part of the area within the frame; (c) positioning the frame on a first thin-layer lignocellulose composite; (d) positioning a second thin-layer composite on top of the frame; (e) pressing the panel to form a panel having two substantially flat surfaces formed by the thin-layer lignocellulose composites, and at least one of steps (f) or (g), wherein (f) comprises the step of making at least one cut into a substantially flat surface of at least one of the thin-layer composites to provide a raised surface, and (g) comprises the step of attaching at least one thin-layer lignocellulose plant-on structure to the surface of at least one of the thin-layer lignocellulose composites to form a raised surface.

In one embodiment, the raised surface provided by the plant-on and/or the cut-out portion of the thin-layer lignocellulose composite may be used to provide the outer surface of a door panel with a pattern. The pattern may provide a single-paneled door with a desired design feature. Alternatively, the pattern may be coordinated with other panels of a multi-paneled door so as to create a door having the appearance of a single panel door. For example, the raised surface provided by the plant-on and/or the cut-out portions may be used to form a garage door having multiple horizontal panels that has the appearance of a single panel spanning the vertical axis of the garage door.

The plant-ons may be positioned on a door comprising a substantially flat, or flush thin layer composite door skin. Alternatively, the plant-ons may be positioned on a door skin that has been cut out so as to form a raised surface in addition to the raised surface provided by the plant-on.

The thin-layer composite and the plant-on may both be made of the same lignocellulose material. In one embodiment, a lignocellulosic material comprises a lignocellulosic fiber and a resin. For example, the lignocellulose material used for the plant-ons and the thin-layer composite to which the plant-on is attached may comprise medium density fiberboard made with a melamine-formaldehyde resin.

In some cases, the plant-ons are only used for the outside surface of the door panel or door. The thin-layer used for the surface of the door that does not comprise a plant-on structure may comprise a material that is the same as, or different than, the material used for the thin-layer composite that comprises the plant-on. In one embodiment, the thin-layer used on the face of the door panel that does not comprise a plant-on (e.g., the inside door skin) is also a lignocellulose composite. For example, a high density fiberboard (HDF) or a medium density fiberboard (MDF) thin-layer composite may be used for the inside door skin. In some situations, because the inside of the door is not as exposed to the elements as the outside of the door, a thin-layer composite that is less weather resistant may be used.

The plant-ons may be adhered onto the thin-layer composite using a polyvinyl acetate glue or a hot-melt glue. Other adhesives, such as double-sided sticky tape may also be used. Additionally, and/or alternatively, the plant-ons may be positioned using small fasteners such as nails. Also, a sealant may be used to prevent delamination of the applied plant-ons from the panel. In one example embodiment, an acrylic silicone caulk sealant may be used. Also, both the thin-layer lignocellulose composite and the plant-on may comprise a resin. Thus, in one embodiment, the plant-on may be bonded to the thin-layer composite by pressing the plant-on onto the thin-layer composite such that the two composites form a singular composite and the plant-on becomes part of the thin-layer composite door skin.

The plant-ons may be a variety of shapes and sizes such that they stand out from the surface of the garage door to provide raised surface or relief. In various alternative embodiments, the plant-ons may range from about 1/16 to 2 inches in thickness, or from about ⅛ inch to 1 inch in thickness, or from about ¼ inch to ¾ inch in thickness. In one example embodiment, the plant-on may be about ⅜ inch thick.

As described above, the thin layer composite may comprise cut-out portions as a mean to form a raised surface. In one embodiment, the cut-out portions may be substantially linear, to appear as spaces between plank boards. For example, grooves may be spaced apart in a regular fashion across the surface of the thin-layer composite. Or the cut-out portions may be non-linear in shape, such that the raised portions appear as decorative moldings. In one embodiment, the cut-out portions are grooves that may range from about 1/16 to ½ inch deep into the surface of the thin layer composite and from about 1/16 to 1 inch wide across the groove. In an embodiment, grooves about ⅛ inch deep and about ⅜ inch wide across may be used. Also, the spacing between the cut-out portions may be varied. Where the raised surface is designed to appear as planking, the grooves may be spaced apart in a regular fashion. In one example embodiment, grooves may be spaced about four to eight inches apart.

The thin-layer composite comprising a raised surface may comprise a variety of thickness ranges based in part, on the method used to make the raised surface. For example, where the thin-layer composite is cut out at least in part, a thicker composite may be used. In an embodiment, where a portion of the thin-layer composite is cut out, the thin layer composite may range from about ⅛ inch to about 1 inch, or from about ¼ inch to about ½ inch in thickness. Alternatively, where plant-ons are used to form the raised surface, the thin layer composite may be somewhat thinner. For example, where plant-ons are used to provide a raised surface, and the thin-layer composite is not cut out, the thin-layer composite may range from about 1/16 inch to about ½ inch in thickness, or from about ⅛ inch to about ¼ inch in thickness.

The frame may comprise at least two vertical stiles and two horizontal rails and a thin-layer composite comprising the inner face of the door. To provide an interlocking junction between adjacent panels of the garage door, the rails may be banded with pieces of pine or other types of wood to provide a means to have adjacent panels interlock. The band may include a protruding element (i.e., a tongue), or the pine band may include a groove so that the protruding element on the end of one garage panel may be inserted into a groove on another panel to provide an almost seamless, interlocking junction between the two panels. In one embodiment, the frame is made using laminated veneer lumber (LVL).

Once assembled, the panel may be exposed to conditions of elevated temperature and pressure to facilitate adhering the panel parts to one another. The panel may then be primed. Also, the process may include the step of placing windows in the door. The window panes may be made of glass, or plexiglass, or the like. The part of the panel surrounding the glass panels may be flush with the outer surface of the panel, or it may comprise a plant-on or other type of trim to accentuate the window pane. Finally, the panel may assembled to form a garage door. The door may be further decorated with hardware such as handles, knobs, knockers, straps, clavos, and the like.

Multi-Paneled Composite Garage Doors Having A Single-Piece Look

Thus, the present invention comprises products, such as door panels and doors, made using a thin-layer lignocellulose composites that comprises a region of increased thickness to provide at least one raised surface, such that the surface comprises the appearance of wooden planking and/or wooden trim. The raised surface may comprise a lignocellulose composite plant-on structure in communication with the thin-layer lignocellulose composite. Alternatively, and/or additionally, the raised surface may be formed by making cuts in a portion of the thin-layer lignocellulose composite to thereby provide a raised surface in a portion of the composite that is adjacent to the cut-out portion.

The plant-on structures and/or the cut-out portions may be positioned to provide the door panel or door with a unique design. Because both the surface of the panel and the plane-on are made from a lignocellulose composite, the plant-on may be bonded to the door panel in such a manner as to become part of the door skin surface. Also, the doors may have the look and feel of solid wood doors.

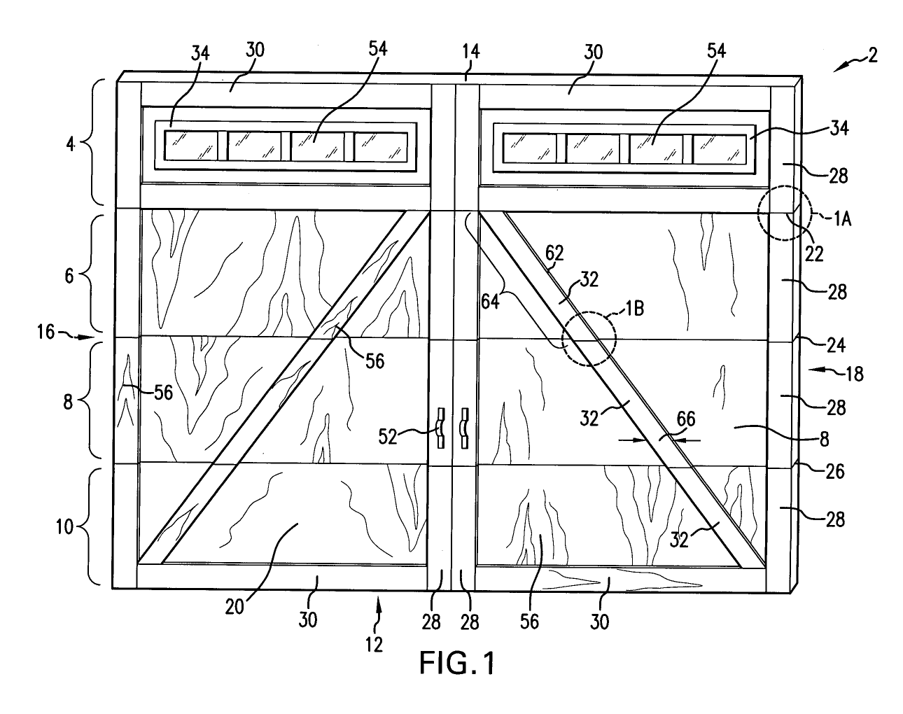

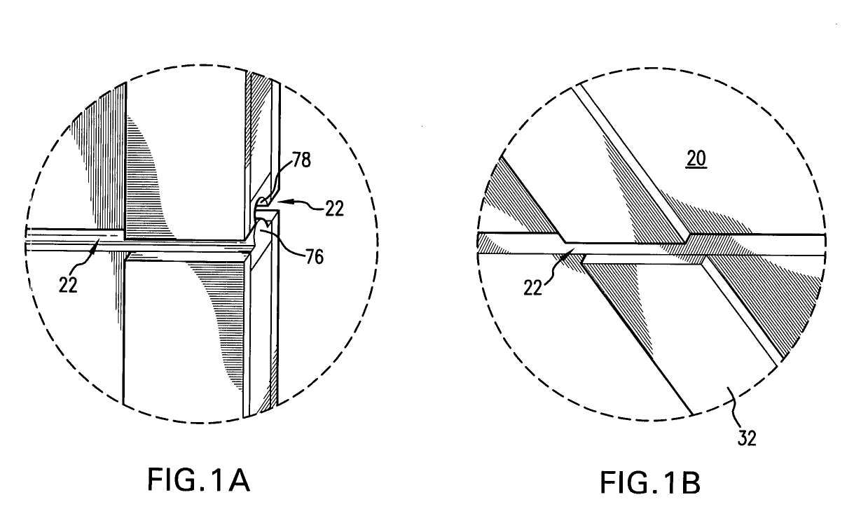

In one exemplary embodiment, the present invention may comprise a multi-paneled composite garage door that has the appearance of a single panel door. Various illustrative embodiments of exemplary garage doors and garage door panels of the present invention are shown in FIGS. 1-6. In the figures, various embodiments of a general design feature may be indicated. For example, the general design feature of a panel or a plant-on are shown as various embodiments of a panel (e.g., 4, 6, 8, or 10) or a plant-on (e.g., 28, 30, or 32). Also, while the invention is illustrated as being applied to the manufacture of garage doors, it may be applied to the manufacture of various wood-based products where the application of a raised surface may be desired. Thus, the plant-on structures of the present invention may be used to add a design to other types of doors, panels, walls, window frames, or almost any building structure.

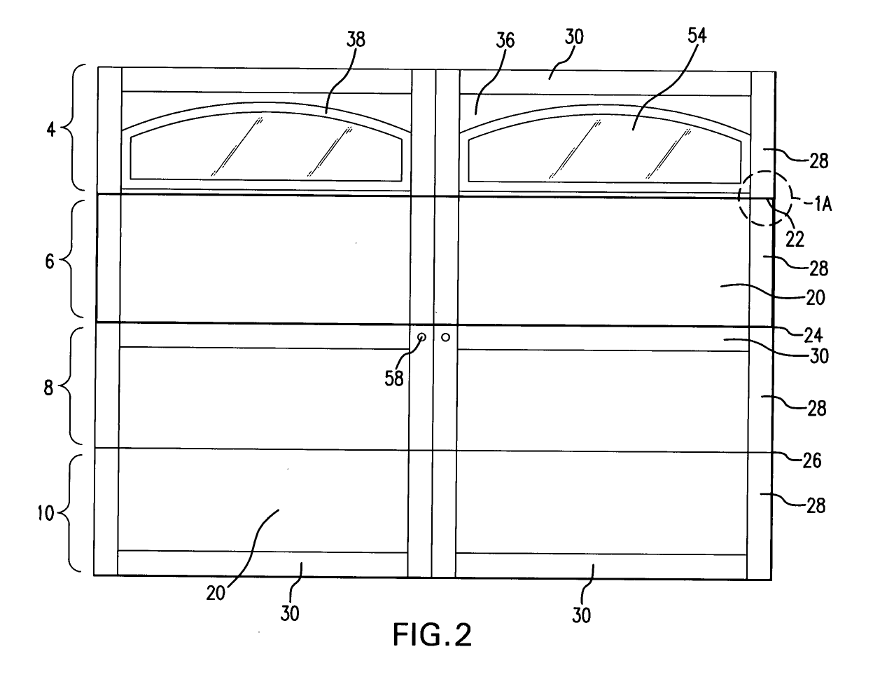

Referring now to FIG. 1, the garage doors 2 shown may comprise multiple composite panels 4, 6, 8, and 10, separated at junctures 22, 24, and 26. In FIG. 2, panel 6 is outlined to show the extent of the panels. Thus, it can be seen that the door may be continuous across its horizontal axis (see e.g., lower surface 12 and upper surface 14), but may be comprised of separate panels across its vertical axis (see e.g., left side 16 and right side 18). Thus, as shown in the exploded view of FIGS. 1A and 1B, although the adjacent panels 4, 6, 8, and 10 appear to form a single unified piece, there is actually a function 22, 24, and 26, between the panels. In addition, the panels may be fashioned so that one panel may interlock with another door panel. For example, as illustrated in the exploded view shown in FIG. 1A, the seam 22 between panels 4 and 6 may comprise a protruding portion or tongue 76 on one panel, that fits into a groove 78 on an adjacent panel.

FIG. 1 shows an embodiment wherein multiple plant-ons have been positioned on the surface of the outer door skin of a garage door. By the positioning of various plant-ons on the outer surface of the door panel 20, the overall appearance of the door is not that of four horizontal panels, but of two single-panel swing doors. For example, plant-ons 28 (FIG. 1) may span the vertical length of the door, and mesh almost seamlessly at junctions 22, 24, and 26, to appear as a single vertical trim on the face of the door. Also, diagonally placed plant-ons 32 provide a single, unified design feature to create the impression that the door shown in FIG. 1 is actually two single paneled doors that may swing open, rather than a roll-up door made of four horizontal panels (4, 6, 8, and 10). Also, hardware pieces such as handles 52 may be used to further create the impression that the door shown in FIG. 1 is actually two single paneled doors that may swing open, rather than a roll-up door made of four horizontal panels. Even horizontal plant-ons 30, although they may not span different panels, provide a design that is coordinated with the other plant-ons so as to create the impression that the door shown in FIG. 1 is actually two single-paneled swing doors.

Both the outer surface of the garage door panel 20, and the plant-ons (e.g., 28, 30, and 32) may be made of a lignocellulose composite. For example, the thin-layer composite forming the outer surface and the plant-ons may both be made of the same lignocellulose material. In one embodiment, the lignocellulose material may comprise medium density fiberboard made using a melamine-formaldehyde resin.

The lignocellulosic composites used for the thin-layer lignocellulose composites (e.g., door skins) and the plant-ons of the present invention may comprise a range of lignocellulose fiber concentrations. Thus, in an embodiment, the composite mixture may comprise about 50% to about 99% by weight of lignocellulose fiber. In another embodiment, the composite mixture may comprise about 80% to about 95% by weight of lignocellulose fiber.

The lignocellulose composites used for the thin-layer door skins and the plant-ons may include a resin. The resin may be a formaldehyde-based resin, an isocyanate-based resin, other thermoplastic or thermoset resins, or other suitable material. Formaldehyde-based resins typically used to make wood composite products include phenol-formaldehyde, urea-formaldehyde, or melamine-formaldehyde resins. Phenol-formaldehyde resins provide good water-resistance, but may require a high temperature cure. Also, phenol-formaldehyde resins may be sensitive to the amount of water in the wood as excess water can inhibit the high temperature cure. Urea and melamine-formaldehyde resins do not require a high temperature cure, but may require a higher resin content to provide comparable water-resistance in the thin-layer composite product. For example, for the manufacture of the thin-layer lignocellulose door skins used for the attaching the plant-ons, melamine-formaldehyde resin, commercially available from Georgia Pacific (Atlanta, Ga.), Dynea (Portland, Oreg.), or Borden Chemical (Greensboro, Ga.) may be used.

The amount of resin used in the thin-layer composite and/or the plant-ons may be varied based on the type of resin being used, the type of lignocellulose fiber in the composite, the moisture level in the lignocellulosic fibers, and the type of thin-layer composite being made. For example, in alternate embodiments, the amount of resin may range from about 1 to 25% by weight of the composite, or from about 3 to 19% by weight of the composite, or from about 5 to 14% by weight of the composite.

The lignocellulosic composite mixture used for both the thin-layer door skins and the plant-ons may further comprise at least one type of wax or other suitable material. The wax may impart additional short-term water repellency to the wood composite. The type of wax used is not particularly limited, and waxes standard in the art of wood fiber processing may be used. In one embodiment, the wax may increase the water repellency of the wood. The wax selected should be stable to the temperatures used for pressing the lignocellulose/resin mixture into a thin layer and should not adversely affect the aesthetics or subsequent processing (such as priming or gluing) of the lignocellulose composite. For example, the wax may be a natural wax or a synthetic wax generally having a melting point in the range of about 120° F. to about 180° F. Waxes used may include, but are not limited to, paraffin wax, polyethylene wax, polyoxyethylene wax, microcrystalline wax, shellac wax, ozokerite wax, montan wax, emulsified wax, slack wax, and combinations thereof. In one embodiment, the mixture may comprise up to about 2% by weight of wax. In one embodiment, about 1% by weight wax is used.

Referring again to FIG. 1, using a lignocellulose material allows for patterns simulating wood grain 56 to be included as part of the surface of the garage door. As used herein, a thin layer lignocellulose composite comprising is substantially flat, and thus alone, does not comprise a raised surface. Because the plant-ons and the thin-layer composite used for the outer surface of the door are made of lignocellulose, the grain pattern 56 may be formed using dies etched with a grain pattern to form the thin-layer composite 20 and/or the plant-on (e.g., 28, 30, and 32).

Also, using a lignocellulose substrate to form the plant-ons and the thin-layer composite used as the outer surface of the door, allows for priming and painting of the garage door in a manner similar to solid wood. Thus, a variety of patterns and colors may be used with the composite garage doors of the present invention.

The plant-ons may be a variety of shapes and sizes such that they stand out from the surface of the garage door to provide raised surface or relief. In various alternative embodiments, the plant-ons may range from about 1/16 to 2 inches, or from about ⅛ inch to 1 inch, or from about ¼ inch to ¾ inch in thickness 62 (FIG. 1). In one example embodiment, the plant-on may be about ⅜ inch thick. The width 66 and length 64 (FIG. 1) of the plant-ons may vary depending upon the size of the door panel and the size of the trim required. On alternate embodiments, the plant-ons may range from about ¼ inch to 18 inches in width, or from about 1 inch to about 12 inches in width, or from about 3 inch to about 10 inches in width. The length of the plant-on may also vary, but generally will not be longer than the diagonal length of the panel. Also, different plant-ons on the same face of a door may be different sizes. For example, in one embodiment, the plant-ons 28, 30, and 32 used for the border shown in the door of FIG. 1 may be different sizes.

Still referring to FIG. 1, the door panel may comprise translucent panels 54 (e.g., windows) inserted within the perimeters of the frame. The surface of the garage door panel surrounding the window may be the door skin itself, or it may comprise a trim 34 to accentuate the window pane. In one embodiment, the trim may be a lignocellulose plant-on.

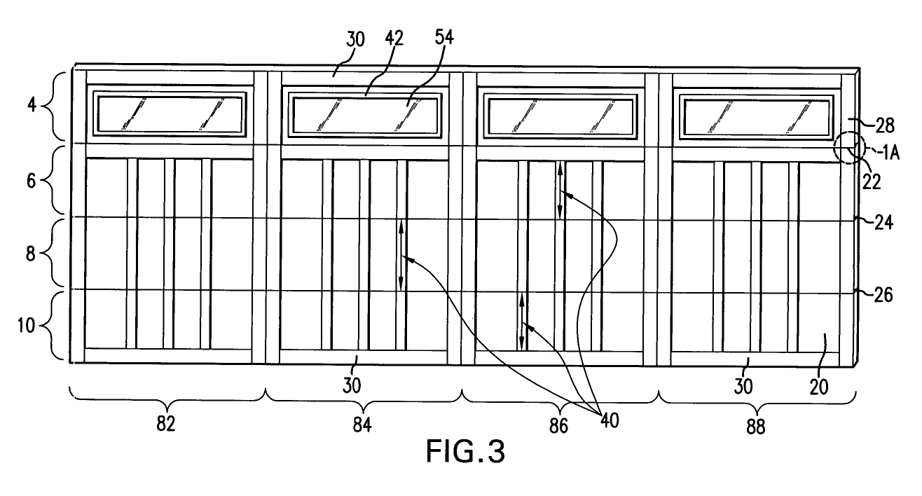

The panel itself may be sized to fit a standard garage door. In one embodiment, the panels are 78 to 144 inches across for use as a single car garage door (e.g., FIGS. 1 and 2). Alternatively, panels may range from 192 to 216 inches across for use as two car garage doors (e.g., FIGS. 3-6). Also, the vertical axis (i.e., height) for the panel may vary as needed. In one embodiment, four panels may be used for a garage door. Alternatively, three to six panels may be used for a garage door. Or, in some cases, the garage door may comprise a single panel. In some cases, panels of different sizes may be used for a single door. For example, in the case of a garage door including windows as part of the top panel, a larger top panel may be used with smaller lower panels. In one example embodiment, a top panel 24 inches in height may be used with three 20 inch lower panels. Or, four 21 high inch panels may be used. For example, where the window is 16 inches high, a 24 inch high panel may be preferred. In contrast, a 13 inch window may be fitted into a 21 inch high panel.

FIGS. 2-6 show alternative embodiments of the garage doors and door panels of the present invention. For example, FIG. 2 shows the use of plant-ons 36 and 38 to outline an arched window-pane 54. Also, placement of vertical plant-ons 28, and horizontal plant-ons 30, as well as knobs 58 provides the appearance of two single-paneled swinging doors.

FIG. 3 provides a schematic illustration of double (i.e., two vehicle) garage door of the present invention. Similar to FIGS. 1 and 2, FIG. 3 shows the use of multiple vertically placed plant-ons 40 to create the impression of vertical panels spanning the three bottom panels (6, 8, and 10) of the door. Also, placement of the outer vertical plant-ons 28, and horizontal plant-ons 30, provides the appearance of four single-paneled swinging doors 82, 84, 86, and 88.

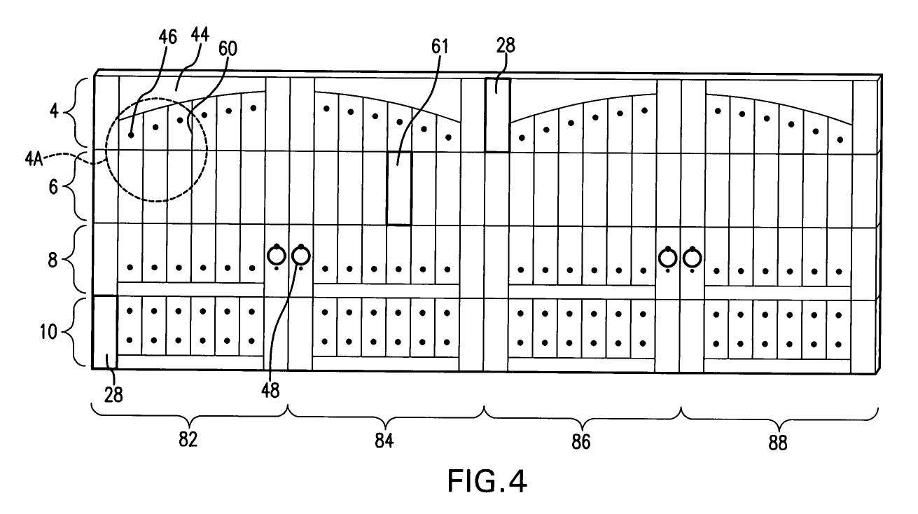

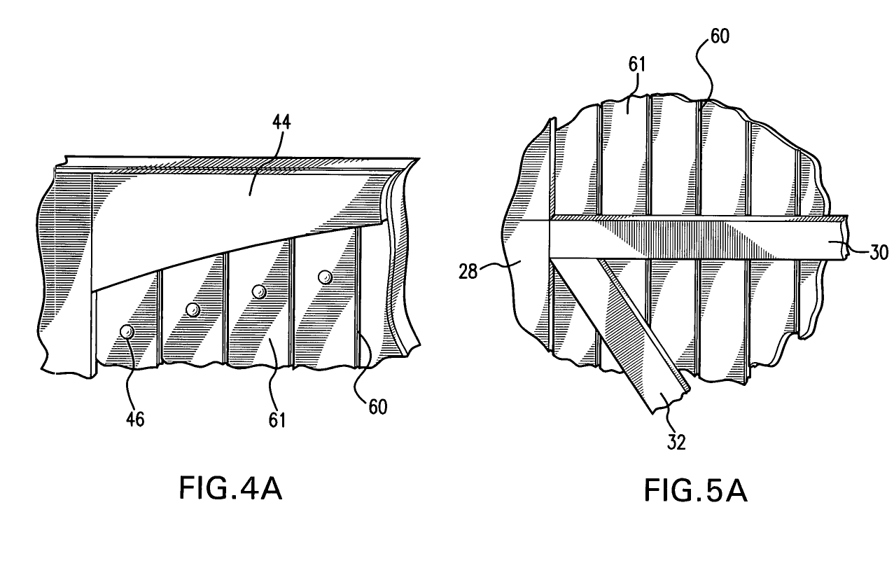

FIG. 4 illustrates another embodiment, in which portions of a ¼ inch thin-layer flush (i.e., substantially flat) lignocellulose composite may be cut-out to create a pattern. For example, grooves 60 may be routed from a ¼ inch thin-layer lignocellulose composite door skin to create a pattern resembling multiple boards placed in a parallel fashion (FIG. 4). Thus, in FIG. 4, each panel (4, 6, 8 and 10) is cut out to provide grooves 60. In this way, the portions of the door skin that is not cut out 61 resemble plank boards laid adjacent to one another. The panel may also comprise a plant-on (e.g., 44 and 28), positioned on top of the thin-layer lignocellulose door skin that has been cut-out at least in part. Thus, the door of FIG. 4 provides the appearance of multiple planks that are laid side to side and that are bordered with a wooden trim to provide the arch design and frame of the door. The positioning of the plant-ons 28 and 44 relative to the cut-out door skin 61 is shown as a perspective view in FIG. 4A. Also shown are decorative handles 48 and knobs 46 that convey the appearance that the door of FIG. 4 is made of four swinging door panels 82, 84, 86, and 88, rather than four horizontal panels 4, 6, 8, and 10.

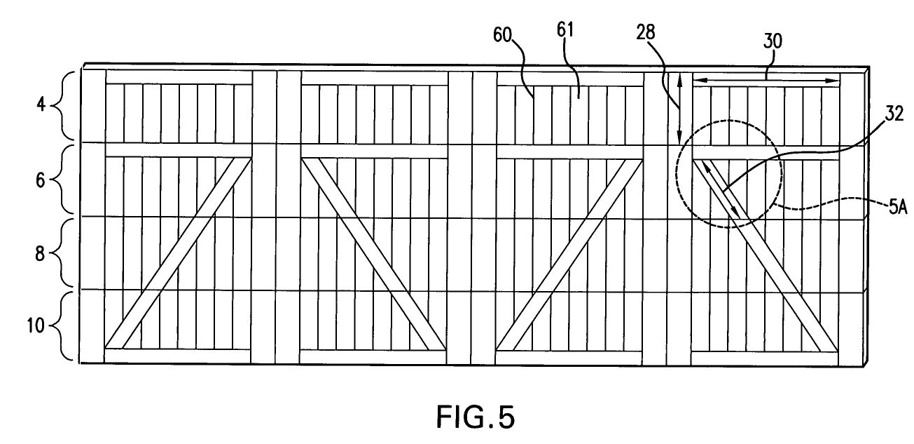

FIG. 5 illustrates another embodiment in which portions of a ¼ inch thin-layer flush (i.e., substantially flat) lignocellulose composite are cut-out to create a pattern which is further accentuated by the positioning of plant-ons on top of the door skin. As shown in FIG. 5, grooves 60 may be routed from a ¼ inch thin-layer lignocellulose composite door skin to create a pattern resembling multiple boards 61 placed in a parallel fashion. The panel may also comprise plant-ons 28, 30, and 32 that are positioned on top of the door skin that has been cut-out at least in part. The positioning of the plant-ons 28, 30, and 32 relative to the cut-out door skin 61 is shown as an enlarged, perspective view in FIG. 5A. Thus, similar to the door of FIG. 4, the door of FIG. 5 provides the appearance of multiple planks that are laid side to side and that are bordered with a wooden trim to convey the appearance that the door of FIG. 5 made of four swinging or sliding door panels, rather than four horizontal panels 4, 6, 8, and 10.

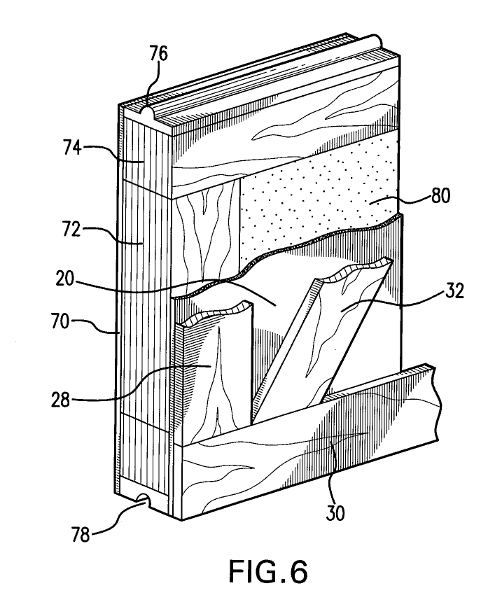

An example embodiment showing the components of a composite garage door panel of the present invention is shown in FIG. 6. Thus, as illustrated in FIG. 6, the composite door panels of the present invention may comprise a frame comprising at least two vertical stiles 72 and two horizontal rails 74. Generally, three vertical stiles are preferred for a panel that spans the width of a single vehicle garage door and five to seven vertical stiles may be used for a panel that spans the width of a two vehicle garage door. As is known in the art, the stiles may be positioned such that two stiles provide the perimeter of the frame and the other stiles are spaced equidistant from the end stiles and from one another. For example, a panel for a single car garage door may comprise two exterior (perimeter) stiles and one center (interior) stile. The frame may be made using LVL, although other types of lumber may also be used. The panel may also comprise a first thin-layer composite 70 comprising the inside face of the door and a second thin layer composite 20 comprising the outside face of the door. The rails 74 may be banded with pieces made of pine or other types of wood to provide a means to have adjacent panels interlock such that a extruding element (e.g., tongue) 76 on one panel may be inserted into a groove 78 on another panel to provide an almost seamless junction between the two panels.

As described herein, exemplary doors and door panels according to the present invention may comprise a core synthetic polymer 80, such as expanded polystyrene (EPS) or polyurethane foam, emplaced within, and bounded by the frame and the two thin-layer composites that form the inner and outer surfaces of the door (e.g., door skins). In one embodiment, expanded polystryrene having a density of from about 1.0 to about 1.5 pounds per cubic foot (pcf) is used. Polymer products that may be used as the core are commercially available from Iowa EPS Products, Inc. (Des Moines, Iowa) or Plymouth Foam (Plymouth, Wis.).

The surface of the garage door facing the inside of the garage (e.g., 70, FIG. 6) may not require a design to the extent as may be desired on the outside facing surface (e.g., 20, FIG. 6) of the door. Thus, in many cases, the inside facing surface of the garage door panel may comprise a smooth surface. Or, a surface including a grain pattern to simulate natural wood may be used. The thin-layer composite used on the inside facing surface of the garage door panel may comprise a material that is the same as, or different than, the material used for the outside facing surface of the panel. For example, in certain applications, plastic or metal may be used as the inside facing surface of the garage door panel. Generally, however, the thin-layer composite used on the inside facing surface of the garage door panel is a lignocellulose composite. For example, a high density fiberboard (HDF) door skin may be used for the inside facing surface of the door. In one example embodiment, a flat, ⅛ inch thick, high density fiberboard (HDF) door skin such as those commercially available from Georgia Pacific (Atlanta, Ga.), or Unilyn (Charlotte, N.C.) may be used for the inner garage door surface.

As shown in FIG. 6, the thin-layer composite 20 comprising the outside surface of the door may comprise a plurality of plant-ons 28, 30, and 32, to form a raised surface. As described above, the plant-ons may be a variety of shapes and sizes such that they stand out from the surface of the garage door to provide a raised surface or relief. Shown in FIG. 6 is a garage door panel having plant-ons 28, 30, and 32 adhered to the surface of the outer door skin 20 so as to provide the pattern for the garage door illustrated in FIG. 1. In one embodiment, the lignocellulose material may comprise medium density fiberboard made using a melamine-formaldehyde resin.

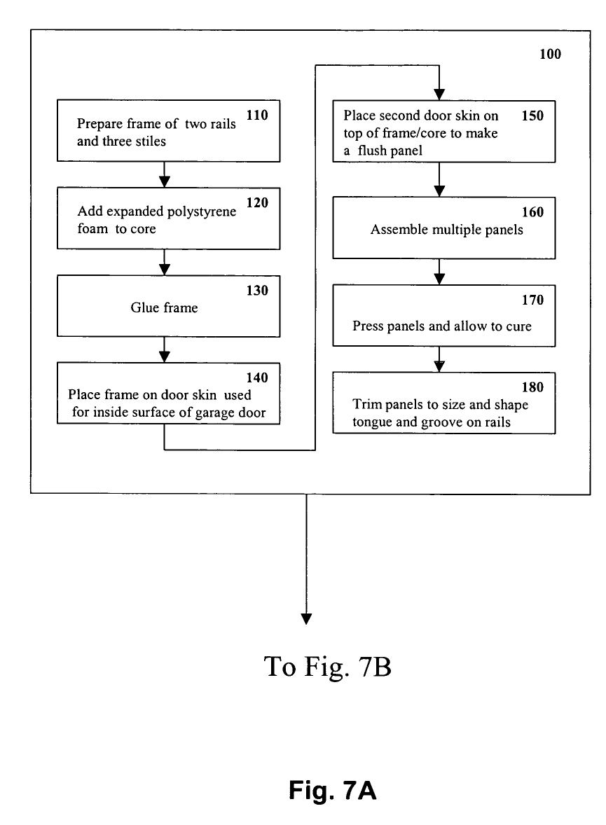

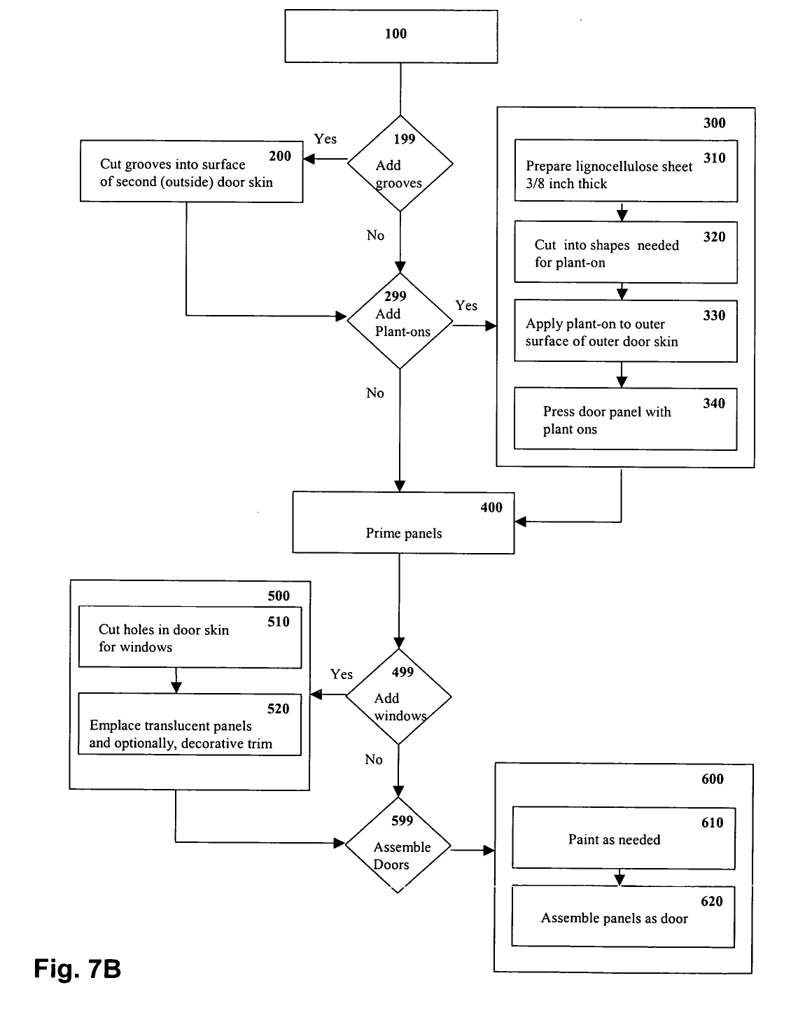

Embodiments of the present invention also include processes to make products such as composite garage doors and garage door panels comprising a raised surface. A schematic representation of a process that may be used to make composite garage door panels and doors of the present invention is provided in FIG. 7.

As shown in FIG. 7, a first step of assembling a product comprising a raised surface to resemble wooden planking and/or trim may comprise making a flush panel 100. As used herein, a flush panel is a panel having a substantially flat surface. For example, to assemble a flush panel, a frame comprising two or three stiles and two rails for a single vehicle door, or five to seven stiles and two rails for a double vehicle garage door, may be assembled using either glue or fasteners as is known in the art 110. For example, the frame may be assembled by stapling the frame together using aluminum corrugated staples. Next, small aluminum nails may be inserted in the edges of the stiles, and a material to form a core is positioned inside the frame by inserting the nails in the edges of the foam 120. In one embodiment, an expanded polystyrene foam core is applied within the perimeter of the frame.

At this point, a glue may be applied to the frame so that the frame may be attached to the door skins 130. In one embodiment, the frame with the core in place may be sent through a roller that applies a glue to the frame. For example, in an embodiment, a polyvinyl acetate glue employing an aluminum chloride catalyst may be used to glue the frame to the door skins.

The assembled frame may then be positioned on a thin-layer lignocellulose composite that will form the inside surface of the garage door 140 (FIG. 7A). These door skins may be smooth, or may have a grain pattern. In one embodiment, a high density fiberboard may be used.

To make thin-layer lignocellulose composites that can be used for the inner and outer door skins, the appropriate lignocellulosic mixture may be pressed into thin-layers using flat or molded dies at conditions of elevated temperature and pressure. The conditions used to form the thin-layer composite door skins of the present invention may include compressing the mixture at an elevated temperature and pressure for sufficient time to allow the resin to interact with the wood fibers. The mixture may initially be formed into a loose mat, pre-compressed into a thinner mat, and the mat placed on a die in the press. In alternate embodiments, the temperature used to press the mat may range from about 250° F. to about 400° F., or from about 280° F. to about 350° F., or from about 290° F. to about 330° F. The exact conditions used will depend upon the equipment used, the exterior environment (e.g., temperature, elevation), the manufacturing schedule, the cost of input resources (e.g., starting materials, electric power), and the like. Also, changes in pressure may require adjustment of the time and/or temperature used for pressing. The pressure during the pressing step may range from about 2500 psi to about 150 psi. Also, the pressure may be applied in a step-wise manner. For example, the pressure during the pressing step may range from about 1200 psi for about 5 to 20 seconds followed by 500 psi for 15 to 80 seconds. For example, in one embodiment, the pressure during the pressing step ranges from about 1200 psi for about 10 seconds to about 500 psi for about 24 seconds.

Various strategies may be used to reduce sticking of the lignocellulosic composite to the dies used for making the resultant thin-layer composite. For example, at least one surface of the die used to press the mat may be exposed to an anti-bonding agent. In an example embodiment, the anti-bonding agent used to coat the die surface may comprise anti-bonding agents known in the art of die pressing such as, but not limited to, CrystalCoat MP-313 and Silvue Coating (SDC Coatings, Anaheim, Calif.), and Iso-Strip-23 Release Coating (ICI Polyurethanes, West Deptford).

At this point, the thin layer composite comprising the outside surface of the door may be placed on top of the frame and core material 150 (FIG. 7A) to make a flush panel. In one embodiment, a ⅛ inch MDF/melamine-formaldehyde thin-layer composite made as described above is placed on top of the frame and core to make a flush (i.e., smooth) panel 150. Alternatively, where the surface will be cut-out to provide a pattern, a thicker, e.g., ¼ inch, MDF/melamine-formaldehyde thin-layer composite made as described above is placed on top of the frame and core to make a flush (i.e., smooth) panel 150.

Generally, multiple assemblies comprising a frame, core, and two flush thin-layer composite surfaces may be assembled 160 then pressed 170 form panels. About 20 to 30 of the assembled structures may be stacked together and placed in a bag press, where they are pressed using air bags. For example, to press about 30 door panel assemblies, a pressure of about 20 to 50 psi may be applied for about 60 minutes. After pressing, the door panels may be allowed to cure. Cure times may vary depending upon the glues and resins used to make the panel, as well as the type of door skin and frame that may have been used. Cure times may range from 20 minutes to as long as 48 hours. In one embodiment, a cure time of about 4 hours is used.

Once the panels have cured sufficiently, they may be trimmed to size and shaped to include a tongue or groove on the rails 180. For example, a door trim saw may be used to trim one or both rails, and one or both outer stiles. Once the panel has been appropriately trimmed to size, the rails may be fashioned to include a portion comprising either a protruding piece (e.g., a “tongue) or a groove. The tongue and groove pieces will allow the panels to interlock in an substantially seamless manner. For example, referring back to FIGS. 1 and 6, the protruding tongue 76 from the upper rail of panel 6, may insert into the groove 78 on the lower rail of panel 4, to provide an interlocking junction at 22.

At this point, and referring now to FIG. 7B, the panels may be sent to have portions of the door skin raised. Thus, the process may include the option 199 of having the flush panels sent to have portions of at least one of the door skins cut out 200. Alternatively, and/or additionally, the process includes the alternative 299 of having the panels sent to have plant-ons applied 300.

Where the panels are to have grooves or other types of cut-out portions emplaced in the outer surface 200, the thin layer lignocellulose composite used as the outer surface may be thicker than a standard ⅛ door skin. For example, a ¼ inch lignocellulose composite may be used. To have grooves cut into the outer door skin, a router may be used to cut grooves in the door panel at predetermined positions 200. For example, in one embodiment, grooves ⅛ inch deep, and ⅜ inch wide are cut in the door panel every six inches.

Once the door panels have been cured and trimmed to size 100, and if needed, part of the surface cut-out to form a pattern 200, individual plant-on structures may be placed on the upper surface of the door skin to form the design required 300 (FIG. 7). As shown in FIG. 7B, a first step may comprise making the plant-on structures that may be applied to the thin-layer lignocellulose composite door skin. To form the plant-on structures, a lignocellulose sheet of the correct thickness is prepared 310 and then cut, or torn, to the correct size 320. For example, the plant-ons may be formed from ⅜ inch MDF thin-layer composite that has been cut to the correct size. In one embodiment, the plant-ons are cut manually. In an alternative embodiment, the plant-ons may be cut using a laser. More specifically, the plant-ons may be shaped using a multiple head ripsaw. For example, individual ⅜ inch MDF sheets may be fed into the rip saw having a blade configuration set to generate the proper widths needed for the plant-on material.

Once the appropriate plant-ons have been prepared, the plant-on may be positioned on the thin-layer lignocellulose composite 330. In one embodiment, an adhesive may be used. For example, an isocyanate adhesive may be applied to the plant-on structure using a roller or glue spreader. Alternatively, a double-sided stick tape (3M) may be used. Or a combination of tape with an adhesive spray may be employed. Also, hot-melt glue, such as National Starch reactive hotmelt may be used to apply the plant-on to a thin-layer lignocellulose composite resin. For example, in one embodiment, the plant-on material is applied using a polyvinyl acetate (PVA) glue catalyzed with aluminum chloride catalyst. The PVA may be applied at a rate of 8 to 10 mils thickness (0.0008-0.0010 inch). Also, the plant on may further secured using a fastener, such as a nail, aluminum brad, tack, or other fasteners known in the art.

Once the plant-on has been positioned on the panel, the panel may subjected to pressure such that the plant-on is fixed onto the outer surface of the door panel 340. For example, the panel may be pressed for at least one hour at 20 psi air pressure using a bag press. Because the plant-on is made of the same lignocellulose material as the door skin to which it is attached, the surface plant-on will be compatible with the surface of the door skin such that the outer door skin will comprise a single structure having raised portions provided by the plant-on.

At this point the panels may be primed with primer 400. The process may further include the option 499 of sending the panels to have windows emplaced in the panel 500. To insert windows, an opening may be cut in the panel surface using, for example, a routing window cutout machine 510. The window frames may then be installed in the opening, caulked, and fastened together with screws 520. Decorative trim may then be put in place 520. The decorative trim may be premade trim such as plastic trim. Or, the decorative trim may comprise a plant-on.

Once the raised surfaces have been added to the panel, and if needed, windows emplaced, the process may include the option 599 of sending the panels to be assembled into doors 600. The pressed panel may be painted as required 610. Using a lignocellulose substrate to form the plant-ons and the thin-layer composite used as the outer surface of the door allows for priming and painting of the garage door in a manner similar to solid wood. Thus, a variety of patterns and colors may be used with the composite garage doors of the present invention. Although a variety of paint types may be used, a waterborne all-acrylic exterior latex finish with a UV inhibitor may be employed to provide a wide range of color choice, relative ease of application and substantial durability. Once the panels have been painted, they may be assembled as doors 620. Or, panels may be assembled as doors and then painted as needed.

### EXAMPLE

Assembly of Panels LVL cutstock with pine banding and polystyrene foam may be used as the core of most types of garage door panels. The frame is preassembled using corrugated aluminum staples and brads so that two rails, three stiles, and two pieces of foam make up a single panel for a one vehicle garage door core. For a two vehicle door, two rails, seven stiles, and four pieces of foam are used. The rails are generally 1.06 inches by 2.25 inches by 96.5 inches and 108.5 inches long for a single vehicle door, and 192.75 inches and 216.75 long for a two vehicle door. The stiles are generally 1.05 inches by 3.125 inches by 15.25 inches to 19.938 inches long, depending on the height of the panel that is being made. The rails are made to include pine bands that will be molded at a later step to provide a tongue on one rail and groove on the other rail that allows each panel to interlock with another panel. The core is a polystyrene foam core (Plymouth Foam, Inc.), and measures 1 1/16 inch by 15¼ inch by 43 7/16 inch to 1 1/16 inch by 19⅞ inch by 49 5/16 inch. The core is positioned in the frame using nails that extend from the frame into the core.

Once the frame is assembled, it is sent to the layup station, where the frame with foam is sent through a glue spread roller (e.g., Black Brothers Glue Spread Roller) The roller applies an Exterior #1 rated PVA glue (National Starch polyvinyl acetate) at a thickness of about 9 mils to each side of the frame. The glue includes an aluminum chloride catalyst. The frame is laid onto a ⅛ inch thick piece of hardboard purchased from Georgia Pacific (Atlanta, Ga.). A ⅛ inch flush or ¼ inch flush skin is then placed on top of the frame. The door panels are assembled on a lift until about 30 door panels are assembled. Once 30 panels have been assembled, the door panels are transferred to a bag press (JELD-WEN, inc., Engineering, Klamath Falls, Oreg.) where they are pressed at 20 to 50 psi of pressure for 60 minutes. When the door panels are removed from the press, they are allowed to stand for about four hours at room temperature to cure. Once the panels have cured, they can then be sized to proper width and length using a door trim saw. As the doors are sized to width, they will also have a tongue and groove molded into them.

Processing Of Panels Into Doors At this point, the door panels are ready to be processed for the addition of grooves or other types of cut-out portions and/or for the addition of plant-ons. The panels that have a thicker door skin (e.g., ¼ inch thick flush skin) go to a router (KVAL, Pentaluma, Calif.) to have portions of the door skin cut out from the skin to form grooves or other types of recessed designs. For example, the router may cut ⅛ inch deep by ⅜ inch wide grooves across the width of a ¼inch door skin. The grooves may be positioned at regular intervals, such as every 6 inches. This gives the door a plank look. If a plant-on or a window is not being added, the panels are now ready to be primed and/or painted and then assembled as full doors. Or, the panels may be sent to the plant-on assembly station if further molding is required.

To add plant-on material, grooved door panels, or panels that have a ⅛ inch thick outer MDF door skin are sent to the assembly station where the plant-on material is added. At the plant-on assembly station, the ripped ⅜ inch thick MDF pieces are put through a glue spreader that adds a PVA-aluminum chloride catalyzed glue (National Starch & Chemical) to one side of the plant on at a thickness of about 9 mils. Also, aluminum brads may be used to secure the plant-on on the panel, as the plant-ons must be precisely positioned. When all pieces are applied to the panels they are again placed in the bag press and put under about 20 psi air pressure for 60 minutes.

After pressing, the panels are marked so that panels do not get mixed together. These doors are then primed and if needed, window panes are added. The panels are primed using JELD-WEN Coatings Acrylic Latex Exterior Primer (JELD-WEN, inc., Seattle). Approximately 4.5 wet mils of primer is applied to the outside face of the panel/skin using a HVLP pump and spray system. The primer is cured in an oven at approximetly 190° F. surface temp. The panels are then stacked and packaged for shipment.

To emplace windows, the window inserts may be purchased (e.g., National Door Lite) in standard sizes or may be custom fitted. The window cutout is done on a KVAL routing machine using templates and jigs designed for each cutout. The windows are installed according to manufacturer's specification. An additional bead of acrylic silicone caulk is applied around the outer frame of the window to insure there will be substantially no water penetration under the frame. The glass used for the window panes may be purchased (e.g., Cardinal Glass, Wis.) in standard sizes or may be custom fitted. The glass is installed in the window frame during assembly. Also, for some panels, plexiglass (e.g., National Door Lite) may be used. The panels with windows emplaced are then packaged and shipped.

It should be understood that various changes and modifications to the embodiments described herein will be apparent to those skilled in the art. Such changes and modifications can be made without departing from the spirit and scope of the present invention and without diminishing its attendant scope and/or advantages.

That which is claimed is:

1. A product comprising a thin-layer lignocellulose composite that comprises a region of increased thickness to provide at least one raised surface, such that the raised surface comprises the appearance of at least one of wooden planking or wooden trim.

2. The product of claim 1, wherein the at least one raised surface comprises a lignocellulose composite plant-on structure in communication with the thin-layer lignocellulose composite.

3. The product of claim 1, wherein the thin-layer lignocellulose composite comprises a portion that is cut out to thereby provide a raised surface in a portion of the thin layer composite that is adjacent to the cut out portion.

4. The product of claim 1, wherein the thin-layer lignocellulose composite comprises a surface of a door panel.

5. The product of claim 4, wherein the panel comprises a panel for a garage door.

6. The product of claim 2, wherein the plant-on structure is adhered to outer surface of the thin-layer composite.

7. The product of claim 2, wherein the thin-layer composite and the plant-on are both made of the same lignocellulose material.

8. The product of claim 7, wherein the lignocellulose material comprises a lignocellulosic fiber and a resin.

9. The product of claim 8, wherein the lignocellulose material comprises a medium density fiberboard.

10. The product of claim 2, wherein the plant-on structure is bonded to the thin-layer lignocellulose composite such that the two composites form a singular composite.

11. The product of claim 1, wherein the thin-layer lignocellulose composite ranges from 1/16 inch to 1 inch in thickness.

13. The product of claim 2, wherein the plant-on ranges from about 1/16 inch to 2 inches in thickness.

14. The product of claim 2, wherein the plant-on ranges from about ⅛ inch to 1 inch in thickness.

15. The product of claim 3, wherein the cut out portion ranges from about 1/16 inch to ½ inch deep and from about 1/16 to 1 inch in width.

16. The product of claim 5, further comprising:
(a) a frame comprising at least two vertical stiles and two horizontal rails;
(b) a core material emplaced within, and bounded by, the frame; and
(c) a thin-layer composite comprising a second face of the door panel;

17. The product of claim 16, wherein the frame comprises a portion shaped to interlock with another door panel.

18. The product of claim 16, wherein the core comprises a synthetic polymer foam.

19. The product of claim 18, wherein the core comprises at least one of an expanded polystyrene (EPS) foam and a polyurethane foam.

20. The product of claim 16, further comprising a translucent panel inserted within the perimeter of the frame.

21. A door comprising a plurality of panels, wherein at least one panel comprises a thin-layer lignocellulose composite comprising a region of increased thickness to provide at least one raised surface, such that the raised surface comprises the appearance of at least one of wooden planking or wooden trim.

22. The door of claim 21, wherein the at least one raised surface comprises a lignocellulose composite plant-on structure in communication with the thin-layer lignocellulose composite.

23. The door of claim 21, wherein the thin-layer lignocellulose composite comprises a portion that is cut out to thereby provide a raised surface in a portion of the thin layer composite that is adjacent to the cut out portion.

24. The door of claim 21, further comprising a garage door.

25. The door of claim 22, wherein the plant-on structure is adhered to the outer surface of the thin-layer composite.

26. The door of claim 24, wherein the raised surface provides at least one panel with a design that is coordinated with at least one other panel of the garage door so as to create a garage door with multiple horizontal panels that has the appearance of a single panel spanning the vertical axis of the garage door.

27. The door of claim 22, wherein the thin-layer composite and the plant-on structure are both made of the same lignocellulose material.

28. The door of claim 22, wherein the lignocellulose material comprises a lignocellulosic fiber and a resin.

29. The door of claim 28, wherein the lignocellulose material comprises a medium density fiberboard.

30. The door of claim 22, wherein the plant-on structure is bonded to the thin-layer lignocellulose composite such that the two composites form a singular composite.

31. The door of claim 21, wherein the thin-layer lignocellulose composite ranges from about 1/16 inch to 1 inch in thickness.

32. The door of claim 22, wherein the plant-on ranges from about 1/16 inch to 2 inches in thickness.

33. The door of claim 23, wherein the cut out portion ranges from about 1/16 inch to about ½ inch deep and from about 1/16 inch to 1 inch in width.

34. The door of claim 21, wherein each panel of the door comprises a frame designed to at least partly interlock with a frame from a different panel on the door.

35. The door of claim 21, further comprising a synthetic polymer foam as a core.

36. A process for making a product comprising a thin-layer lignocellulose composite comprising a region of increased thickness to provide at least one raised surface, such that the surface comprises the appearance of at least one of wooden planking or wooden trim comprising the steps of:
(a) preparing at least one thin-layer lignocellulose composite comprising a substantially flat surface, and at least one of steps (b) and (c) as follows:
(b) making at least one cut into the substantially flat surface of the composite to provide a raised surface; or (c) attaching at least one thin-layer lignocellulose plant-on structure to the surface of the thin-layer lignocellulose composite to form a raised surface.

37. The process of claim 36, further comprising the steps of
(i) assembling a frame for a panel; and
(ii) positioning the thin-layer composite on the frame to form at least part of the outer surface of the panel.

38. The process of claim 37, wherein step (i) precedes step (a) and step (ii) precedes steps (b) and (c).

39. The process of claim 36, wherein the panel comprises a panel for a door.

40. The process of claim 39, wherein the panel comprises a panel for a garage door.

41. The process of claim 38, further comprising the step of placing the frame on a second thin-layer lignocellulose composite prior to positioning the thin-layer composite comprising a region of increased thickness to provide at least one raised surface.

42. The process of claim 38, further comprising filling an area between the perimeter of the frame with a material to form a core prior to positioning the thin-layer composite on the frame.

43. The process of claim 42, wherein the core comprises a synthetic polymer foam.

44. The process of claim 43, wherein the core comprises at least one of an expanded polystyrene (EPS) foam and a polyurethane foam.

45. The process of claim 36, further comprising positioning the raised surface to provide the outer surface of the panel with a pattern that can be coordinated with other panels of a door so as to create a multi-paneled door having the appearance of a single panel door.

46. The process of claim 36, wherein the thin-layer composite and the plant-on are both made of the same lignocellulose material.

47. The process of claim 46, wherein the lignocellulose material comprises a lignocellulose fiber and a resin.

48. The process of claim 46, wherein the lignocellulose material comprises a medium density fiberboard.

49. The process of claim 36, wherein the plant-on structure is attached to the thin-layer lignocellulose composite such that the two composites form a singular composite.

50. The process of claim 36, wherein the thin-layer lignocellulose composite ranges from about 1/16 inch to 1 inch thick.

51. The process of claim 36, wherein the plant-on ranges from about 1/16 inch to 2 inches in thickness.

52. The process of claim 36, wherein the cut out portion ranges from about 1/16 inch to ½ inch deep and from about 1/16 inch to 1 inch in width.

53. The process of claim 37, further comprising inserting a window panel within the perimeter of the frame.

54. A process for making a composite garage door panel comprising the steps of:
(a) assembling a frame for the panel;
(b) optionally, adding a core material to at least part of the area within the frame;
(c) positioning the frame on a first thin-layer lignocellulose composite;
(d) positioning a second thin-layer composite on top of the frame;
(e) pressing the panel to form a panel having two substantially flat surfaces each formed by the thin-layer lignocellulose composites, and at least one of steps (f) or (g) as follows::
(f) making at least one cut into the surface of at least one of the thin-layer composites to provide a raised surface; or
(g) attaching at least one thin-layer lignocellulose plant-on structure to the surface of at least one of the thin-layer lignocellulose composites to form a raised surface.
